(19) United States
(12) Patent Application Publication
(10) Pub. No.: US 2007/0275751 A1
(43) Pub. Date: Nov. 29, 2007

(54) Faceplate having keys for mobile phone

(75) Inventors: Chuan-Shien Yu, Taoyuan County (TW); Ming-Hsun Wu, Taoyuan County (TW); Chih-Chiang Chen, Taoyuan County (TW)

Correspondence Address: TROXELL LAW OFFICE PLLC, SUITE 1404, 5205 LEESBURG PIKE, FALLS CHURCH, VA, 22041, US

(73) Assignee: SPEED TECH CORP., Taoyuan County (TW)

(21) Appl. No.: 11/418,034

(22) Filed: May 5, 2006

(51) Int. Cl. H04M 1/00

(52) U.S. Cl. 455/550.1

(57) ABSTRACT

The present invention provides a faceplate having keys. The keys are defined between protrusions under a film. By pressing down a key, a contact is pushed to be in touch with a circuit board to control the circuit board. Consequently, the faceplate is easily assembled and has a reduced production cost.

### FIELD OF THE INVENTION

The present invention relates to a faceplate; more particularly, relates to a faceplate easily assembled, where components of the faceplate are saved and a production cost is reduced.

### DESCRIPTION OF THE RELATED ART

A general keypad for an electrical device, as shown in FIG. 6, has a faceplate 6 with a first opening 61 and a few second openings 62 of the same figure or of various figures. The first opening 61 is set with a transparent window area. The second opening 62 is set with keys 64; and a soft fixing layer 65 is set at button of the keys 64. The fixing layer 65 has bulges 66 corresponding to the keys 64. The faceplate 6 can be fixed with an electrical device 7, where the bulges 66 on the fixing layer 65 are corresponding to conducting parts 711 on a circuit board 71 of the electrical device 7 severally. When using the keypad, one of the keys 64 is pressed down, a corresponding one of the bulges 66 is pushed to move toward a corresponding one of the conducting parts 711 on the circuit board 71 to be in touch with the corresponding conducting part 711 for operating the electrical device 7.

The components of the keys 63 and the window area 64 are produced through specific and complex processes individually to be assembled with the faceplate 6 separately under required procedures and quality controls. Although the above keypad controls the electrical device 7 by touching the conducting parts 711, the following disadvantages are obvious:

1. The keys 64 and the window area 63 are produced separately so that the total cost are high.

2. The shapes of the keys 63 and the window area 64 have to be tied in with the faceplate 6, which increases the production difficulties.

3. The faceplate 6 has already met its limitation over space utilization and thickness reduction, where it is quite hard to make a further improvement in the industrial design.

Hence, the prior art does not fulfill users' requests on actual use.

### SUMMARY OF THE INVENTION

The main purpose of the present invention is to assemble a faceplate easily, to save components of the faceplate, and to reduce a production cost.

To achieve the above purpose, the present invention is a faceplate having keys for a mobile phone, comprising a transparent film, a thermoplastic urethane (TPU) layer, a buttons layer and a fixing layer, where the transparent film comprises a window area and a keys area; the keys area has a plurality of butting parts defining a plurality of pressing parts; the keys area has a patterns layer being deposed on an end surface of the keys area; the TPU layer is deposed on an end surface of the patterns layer; the buttons layer is deposed on an end surface of the TPU layer; the buttons layer is deposed with a plurality of contacts; the plurality of contacts are corresponding to the plurality of pressing parts one on one; and the fixing layer is deposed on an end surface of the buttons layer. Accordingly, a novel faceplate having keys for a mobile phone is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a perspective view of a preferred embodiment according to the present invention;

FIG. 2 is an explosive view;

FIG. 3 is a cross-sectional view;

FIG. 4 is an enlarged view of A in FIG. 3;

FIG. 5 is a view showing a state of use; and

FIG. 6 is a perspective view of a prior art.

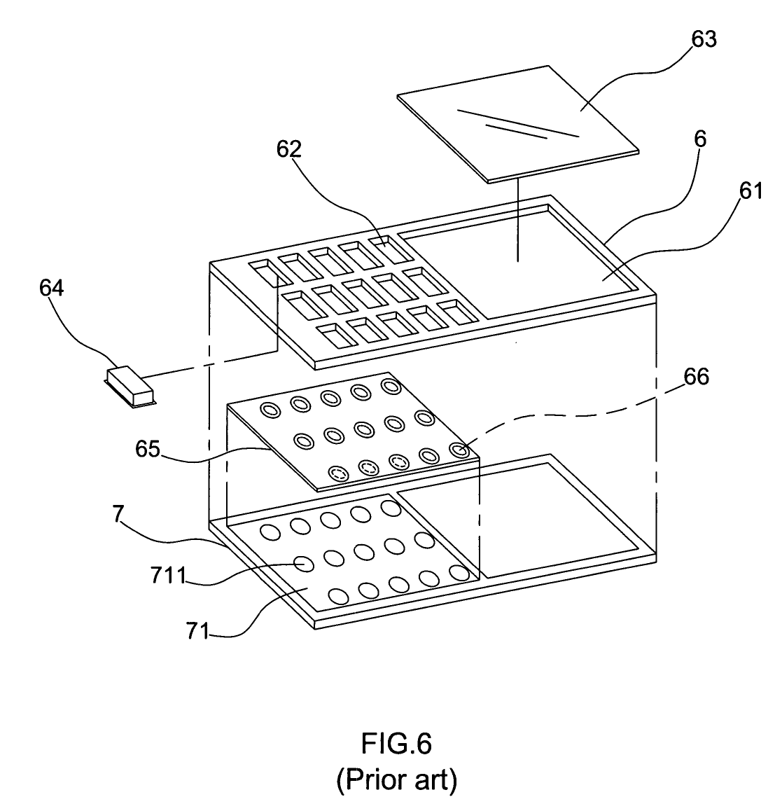

### DESCRIPTION OF THE PREFERRED EMBODIMENT

The following description of the preferred embodiment is provided to understand the features and the structures of the present invention.

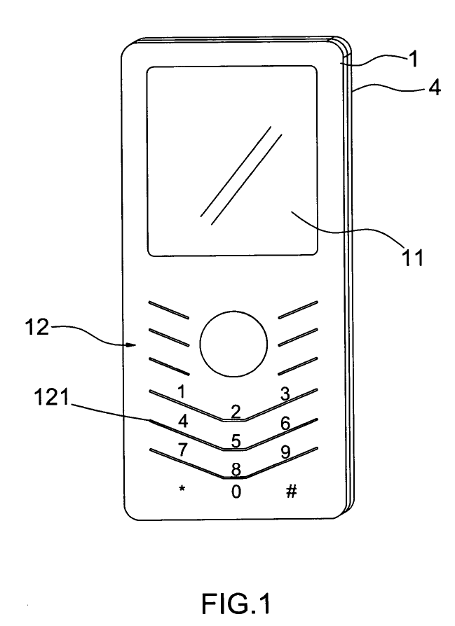

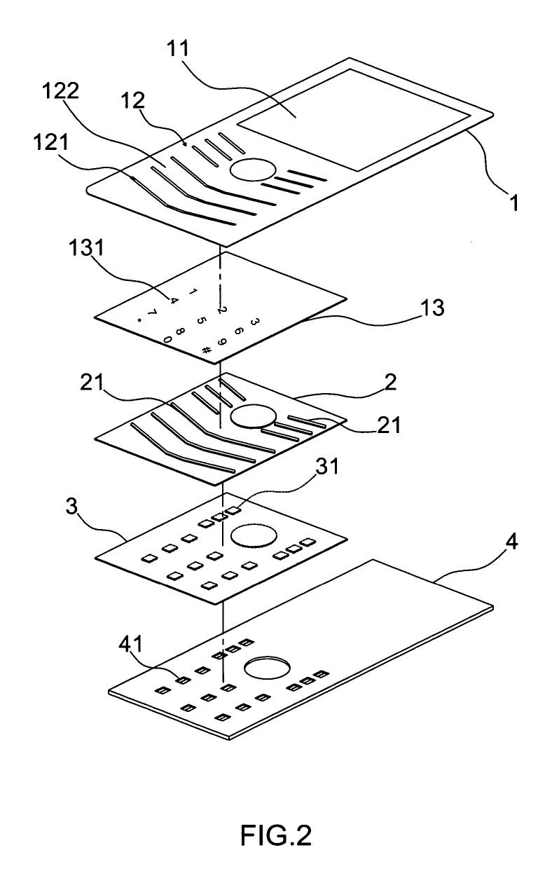

Please refer to FIG. 1 and FIG. 2, which are a perspective and an explosive views of a preferred embodiment according to the present invention. As shown in the figures, the present invention is a faceplate having keys for a mobile phone, comprising a transparent film 1, a thermoplastic urethane (TPU) layer 2, a buttons layer 3 and a fixing layer 4, where the faceplate is easily assembled; the components of the faceplate are saved; and the production cost is reduced.

The transparent film 1 is processed through an abrasion proof treatment and comprises a window area 11 and a keys area 12, where the keys area 12 has a plurality of butting parts 121 defining a plurality of pressing parts 122. The keys area 12 is deposed with a patterns layer 13 on an end surface of the keys area 12; and the patterns layer 13 has a plurality of patterns 131 corresponding to the plurality of pressing parts 122.

The TPU layer 2 is deposed on an end surface of the patterns layer 13; and the TPU layer 2 has a plurality of protrusions 21 corresponding to the plurality of butting parts 121 one on one on an end surface of the TPU layer 2.

The buttons layer 3 is made of rubber, being deposed on an end surface of the TPU layer 2; and the buttons layer 3 is deposed with a plurality of contacts 31 corresponding to the plurality of pressing parts 122 one on one.

The fixing layer 4 is made of plastics, deposed on an end surface of the buttons layer 3; and the fixing layer 4 has a plurality of holes 41 corresponding to the plurality of contacts 31 one on one. Thus, a faceplate having keys for a mobile phone is obtained.

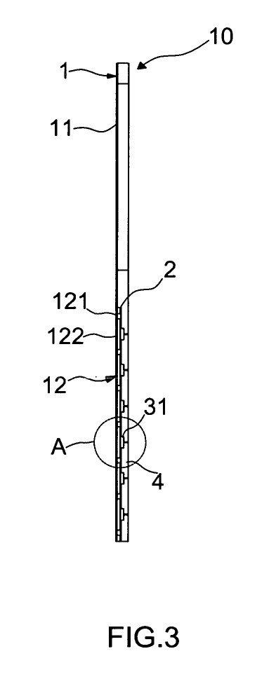

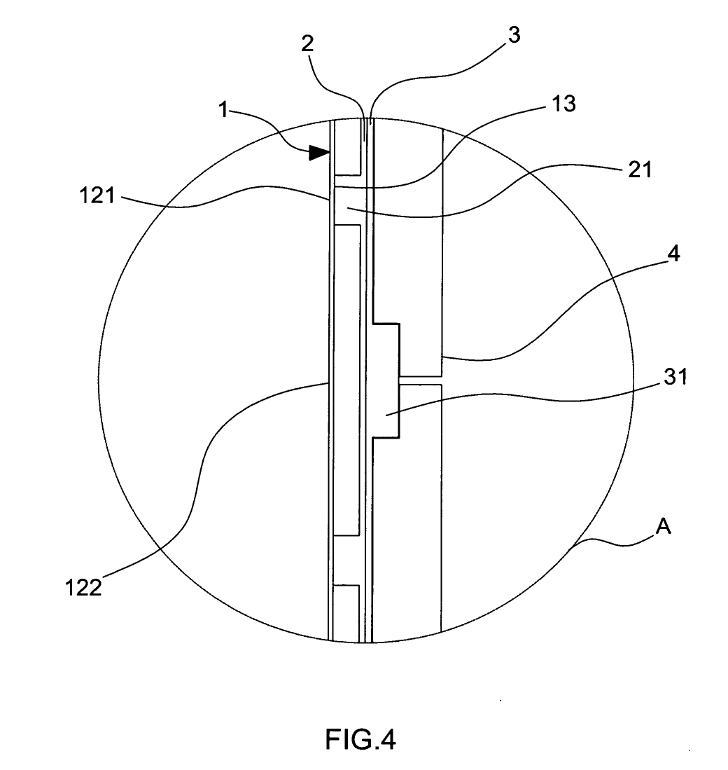

Please refer to FIG. 3 and FIG. 4, which are a cross-sectional view and an enlarged view of A in FIG. 3. As shown in the figures, when assembling the present invention, the transparent film 1 is first processed through an abrasion proof treatment. The transparent film 1 is printed with a patterns layer 13 deposed on the back surface of the transparent film 1, where the patterns layer 13 has a plurality of patterns 131 corresponding to a plurality of pressing parts 122. The transparent film 1 and the TPU layer 2 are gummed together with a surfactant, where the plurality of protrusions 21 are corresponding to the plurality of butting parts 121 one on one. The plurality of contacts 31 are simultaneously corresponding to the plurality of pressing parts 122 one on one. Thus, a faceplate 10 comprising a window area 11 and a keys area 12 is obtained, where the faceplate 10 is easily assembled; the components of the faceplate 10 are saved; and the production cost is reduced.

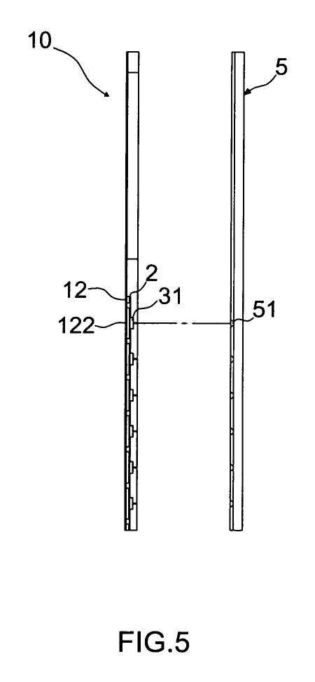

Please refer to FIG. 5, which is a view showing a state of use. As shown in the figure, when using a faceplate 10 according to the present invention, the faceplate 10 is bond with a key circuit module 5 and then a pressing part 122 on the keys area 12 is directly pressed to push a contact 31 on the buttons layer 3 coordinated with the TPU layer 2 so that the contact 31 is connected with a conducting part 51 of the key circuit module 5 to operate the key circuit module 5.

To sum up, the present invention is a faceplate having keys for a mobile phone, where the faceplate is easily assembled; the components of the faceplate are saved; and the production cost is reduced.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A faceplate having keys for a mobile phone, comprising:
a transparent film, said transparent film comprising a window area and a keys area, said keys area having a plurality of butting parts, said plurality of butting parts defining a plurality of pressing parts, said keys area being deposed with a patterns layer on an end surface of said keys area;
a thermoplastic urethane (TPU) layer, said TPU layer being deposed on an end surface of said patterns layer;
a buttons layer, said buttons layer being deposed on an end surface of said TPU layer, said buttons layer being convexly deposed with a plurality of contacts, said plurality of contacts being corresponding to said plurality of pressing parts one on one; and
a fixing layer, said fixing layer being deposed on an end surface of said buttons layer.

2. The faceplate according to claim 1,
wherein said transparent film is processed through an abrasion proof treatment.

3. The faceplate according to claim 1,
wherein said patterns layer has a plurality of patterns; and
wherein said plurality of patterns are corresponding to said plurality of pressing parts.

4. The faceplate according to claim 1,
wherein said TPU layer has a plurality of protrusions on an end surface of said TPU layer; and
where said plurality of protrusions are corresponding to said plurality of butting parts one on one.

5. The faceplate according to claim 1
wherein said buttons layer is made of rubber.

6. The faceplate according to claim 1,
wherein said fixing layer is made of plastics.
